(19) United States
(12) Patent Application Publication
(10) Pub. No.: US 2019/0059637 A1
(43) Pub. Date: Feb. 28, 2019

(54) RESIDUAL WATER CONTAINER FOR AN APPARATUS FOR BEVERAGE PREPARATION AS WELL AS APPARATUS FOR BEVERAGE PREPARATION

(71) Applicant: JURA Elektroapparate AG, Niederbuchsiten (CH)

(72) Inventors: Pascal RUETTI, Neuendorf (CH); Philipp BUETTIKER, Oberbuchsiten (CH)

(73) Assignee: JURA Elektroapparate AG, Niederbuchsiten (CH)

(21) Appl. No.: 16/109,983

(22) Filed: Aug. 23, 2018

(30) Foreign Application Priority Data
Aug. 23, 2017 (EP) 17187523.0

(51) Int. Cl. A47J 31/44

(52) U.S. Cl. CPC A47J 31/4428

(57) ABSTRACT

The residual water container for an apparatus for beverage preparation includes: a dish having at least one interior for receiving residual water and having an opening which is delimited by an upper edge of the dish; a cover for covering a first partial region of the opening of the dish and a flap for temporary covering of a second partial region of the opening of the dish. The flap is pivotable relative to the dish about a pivot axis so that the flap is pivotable between a closed state and an open state, wherein in the open state a pouring opening of the residual water container is exposed through which pouring opening residual water can be poured out over the upper edge of the dish and wherein in the closed state the pouring opening is closed.

### CROSS REFERENCE TO RELATED APPLICATIONS

Applicant claims priority under 35 U.S.C. § 119 of European Application No. 17187523.0 filed Aug. 23, 2017, the disclosure of which is incorporated by reference.

### BACKGROUND OF THE INVENTION

### 1. Field of the Invention

The present invention relates to a residual water container for an apparatus for beverage preparation as well as an apparatus for beverage preparation.

### 2. Description of the Related Art

DE 10 2010 007 143 A1 discloses a coffee machine with a residual water dish for collecting residual water. The residual water dish consists in this case of a dish which is open towards the top, which is only covered in the front region, which is located underneath the coffee outlet and the milk foam outlet, by a dish cover which forms a fixed component of the coffee machine housing. The applicant is furthermore familiar with coffee machines which have a residual water container which has a cover to prevent residual water passing from the dish into the interior of the coffee machine, for example whereby residual water evaporates and penetrates into the interior of the coffee machine as steam and there causes damage to moisture-sensitive components. The cover must however be removed from the dish before emptying the dish in an additional work step in order to prevent the residual water flowing in an uncontrollable manner during emptying through the gap between the dish and the cover and thereby resulting in contamination of the outer side of the residual water container. Such contaminants must be removed by expensive cleaning and drying of the residual water container.

Known from DE 102014204611 B3 is a drip grid which is provided for use in a coffee machine and additionally serves as “storage area for storing containers for receiving beverages”, wherein the drip grid can be arranged on a coffee machine in such a manner that this drip grid is arranged above a residual water container. The drip grid is composed of three support struts and a plurality of cross members. A partial region of the drip grid which extends between two support struts is formed from two sections which can be twisted or pivoted relative to one another about a first axis, wherein one of the two sections is connected to the other (arranged in a fixed position in space) parts of the drip grid in such a manner that this one of the two sections can be twisted or pivoted about a second axis. By pivoting one of the two sections about the second axis, it is achieved that the other of the two sections forms a horizontally aligned surface which (due to the pivoting of the one of the two sections about the second axis) is adjustable in height with respect to the other (arranged in a fixed position in space) parts of the drip grid and thus forms a height-adjustable storage area for drink containers.

### SUMMARY OF THE INVENTION

One object forming the basis of the present invention consists in avoiding the said disadvantages and providing an improved residual water container and an improved apparatus for beverage preparation.

This object is solved by a residual water container according to one aspect of the invention and an apparatus according to another aspect of the invention.

The residual water container according to the invention constitutes a residual water container for an apparatus for beverage preparation comprising: a dish having at least one interior for receiving residual water and having an opening which is delimited by an upper edge of the dish; a cover for covering a first partial region of the opening of the dish and a flap for temporary covering of a second partial region of the opening of the dish. The flap is pivotable relative to the dish about a pivot axis so that the flap is pivotable between a closed state and an open state, wherein in the open state a pouring opening of the residual water container is exposed through which pouring opening residual water can be poured out over the upper edge of the dish and wherein in the closed state the pouring opening is closed.

Residual water can be any type of at least partially liquid waste which accumulates during operation of an apparatus for beverage preparation. In addition to water, for example other liquids such as liquid cleaning agents or solids such as possibly coffee grounds can be contained in the residual water. Residual water accumulates during rinsing processes for cleaning components of the apparatus for beverage preparation. Residual water for example also accumulates when the apparatus for beverage preparation prepares a beverage and dispenses it via an outlet opening without a drink container having been positioned below the outlet opening to intercept the beverage.

When using the residual water container according to the invention, it is possible for example to empty the dish by controlled pouring out of the residual water located therein through the second partial region of the opening of the dish without previously removing the cover from the dish and without this resulting in contamination of the outer side of the dish. Thus, the operator can for example remove the residual water container from the apparatus for beverage preparation with one hand and empty it by tilting the residual water container without needing to use the other hand. Furthermore, it is possible to empty the residual water container according to the invention without this resulting in contamination of the outer side of the residual water container. By using the residual water container according to the invention, it is for example also achieved that the operator is not exposed to the sight of possible contaminants inside the residual water container when he empties the residual water container.

Preferably the flap of the residual water container has at least one projection on a side facing the at least one interior of the dish, wherein the at least one projection has at least one first flow surface, wherein the at least one first flow surface is configured to have residual water flowing out of the dish flowing onto it when tilting the residual water container about a tilt axis at least partially parallel to the pivot axis whereby a torque acting on the flap is produced by means of which the flap is pivoted or by means of which the pivoting of the flap is assisted.

“At least partially parallel” means here that the direction of the tilt axis has a component parallel to the tilt axis or is parallel to the tilt axis.

Preferably the flap has at least one projection on the side facing the at least one interior of the dish wherein the projection is configured as a buoyancy body.

Preferably the residual water container further comprises at least one counterweight, wherein the at least one counterweight is connected to the flap and wherein the at least one counterweight is arranged in relation to the flap and the pivot axis of the flap in such a manner that the counterweight produces a torque acting on the flap in relation to the pivot axis of the flap, which at least partially compensates for a corresponding (i.e. acting on the flap in relation to the pivot axis of the flap) torque produced by a weight force of the flap.

Preferably the at least one counterweight has at least one second flow surface, wherein the at least one second flow surface is configured to have residual water flowing out of the dish flowing onto it when tilting the residual water container about a tilt axis at least partially parallel to the pivot axis whereby a torque acting on the flap is produced, by means of which the flap is pivoted or by means of which the pivoting of the flap is supported.

Preferably the cover has a platform configured as a grid for placing drinks containers thereon, wherein more preferably the platform is arranged on a side of the cover opposite the flap.

Preferably the dish has a base and a side wall, wherein the side wall is configured to run obliquely to the base at least in a partial region.

Preferably the at least one projection lies opposite a partial region of the side wall in which the side wall is configured to run obliquely to the base.

Preferably the cover is connected to the dish, wherein more preferably the cover is connected detachably to the dish, wherein particularly preferably the cover is non-positively and/or positively connected to the dish.

Preferably the flap is attached pivotably to the cover via at least one hinge.

The apparatus for beverage preparation according to the invention comprises a beverage preparation unit and a residual water container according to the invention.

Preferably the residual water container can be removed from the apparatus, wherein the residual water container for removal can more preferably be withdrawn from the apparatus in a substantially horizontal direction.

Preferably in the operating state of the apparatus the residual water container is arranged in the lower region of the apparatus and/or the apparatus has at least one beverage outlet opening below which the cover has a platform for placing drinks containers thereon.

Preferably the apparatus for beverage preparation according to the invention is a coffee machine, more preferably a coffee machine for preparing espresso and/or cappuccino, even more preferably a fully automatic coffee machine, in particular a fully automatic coffee machine for preparing espresso and/or cappuccino.

### BRIEF DESCRIPTION OF THE DRAWINGS

Further details and expedient properties of the invention as well as in particular exemplary embodiments of the residual water container according to the invention and of the apparatus for beverage preparation according to the invention are described hereinafter with reference to the appended drawings. The individual features of the embodiments can be arbitrarily combined with one another as far as is appropriate.

In the drawings,

FIG. 1 shows an oblique view of a residual water container according to the invention according to a first embodiment of the present invention.

FIG. 2 shows a schematic sectional view of the residual water container according to the first embodiment in a closed state.

FIG. 3 shows a schematic sectional view of the residual water container according to the first embodiment in an open state.

FIG. 4 shows a schematic sectional view of the residual water container according to the first embodiment in the open state, wherein the residual water container is opened further than in the situation shown in FIG. 3.

FIG. 5 shows a schematic sectional view of the residual water container according to a second embodiment of the invention in a closed state.

FIG. 6 shows a schematic sectional view of the residual water container according to the second embodiment of the invention in an open state.

FIG. 7 shows a schematic sectional view of the residual water container according to the second embodiment in the open state, wherein the residual water container is opened further than in the situation shown in FIG. 6.

FIG. 8 shows a schematic sectional view of the residual water container according to a third embodiment of the invention in a closed state.

FIG. 9 shows a schematic sectional view of the residual water container according to the third embodiment of the invention in an open state.

FIG. 10 shows a schematic sectional view of the residual water container according to the third embodiment in the open state, wherein the residual water container is opened further than in the situation shown in FIG. 9.

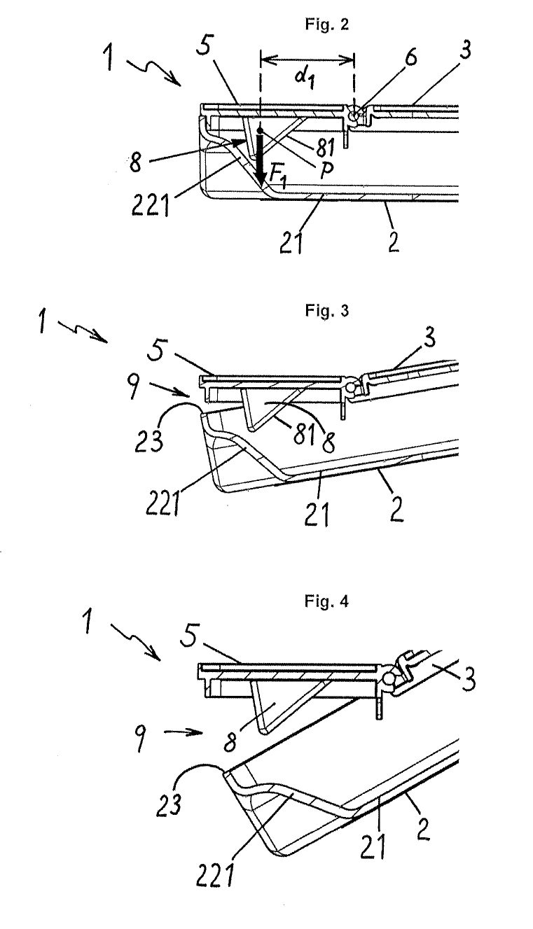

For the sake of clarity in each case only the rear area of the residual water container is shown in FIGS. 2 to 10.

### DETAILED DESCRIPTION OF PREFERRED EMBODIMENTS

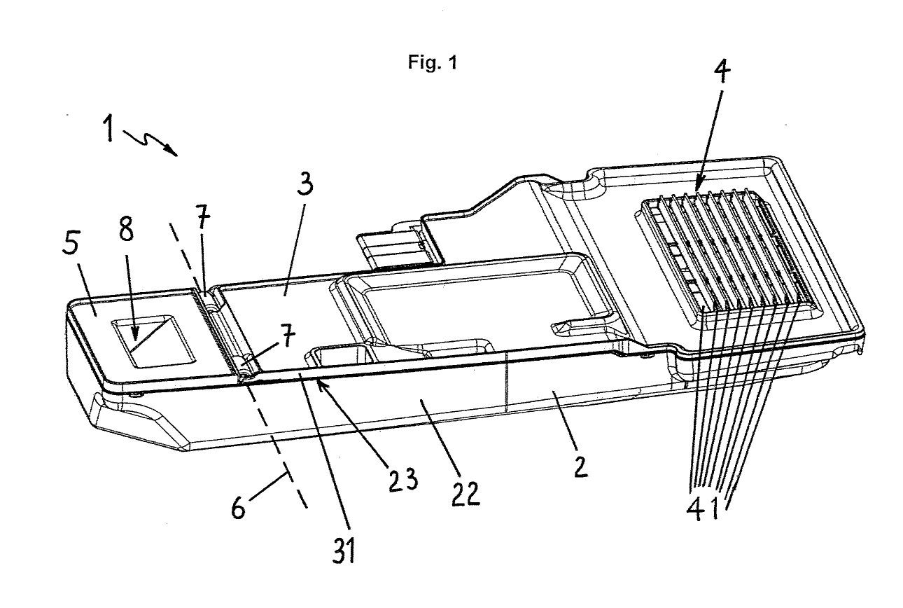

FIG. 1 shows an oblique view of a residual water container 1 for an apparatus for beverage preparation according to a first embodiment of the present invention. The residual water container 1 comprises a dish 2 for receiving residual water. The dish 2 is configured to be open towards the top, i.e. it has a base 21, a side wall 22 and an opening which points upwards in the operating state. The opening is delimited by the upper edge 23 of the dish 2.

A cover 3 is arranged at the upper edge 23 of the dish 2. Preferably the dish 2 and the cover 3 are connected to one another non-positively and/or positively, for example, by placing the edge 31 of the cover 3 on the upper edge 23 of the dish 2. Within the framework of the invention it is also possible that the dish 2 and the cover 3 are adhesively bonded to one another or that the dish 2 and the cover 3 are formed in one piece. The cover 3 has a platform 4. During operation the residual water container 1 is preferably inserted in an apparatus for beverage preparation such as for example a coffee machine so that a drinks container can be placed on the platform 4 below an outlet opening for prepared beverages. The platform 4 has slots 41 and/or holes and/or other liquid-permeable openings. Preferably the platform is configured as a grid. Liquid which is dispensed by the apparatus for beverage preparation via the outlet opening passes through the slots 41 into the dish 21 when no drinks container is placed under the outlet opening.

Within the present invention the designation “front region” is used for the region of the residual water container 1 or the cover 3 in which the platform 4 is arranged. In FIG. 1 this is the right-hand region of the residual water container 1 or the cover 3. Accordingly the designations “rear” and “rear region” are used for the opposite side or the opposite region. In FIG. 1 this is the left-hand region of the residual water container 1 or the cover 3.

Furthermore a flap 5 is arranged at the upper edge 23 of the dish 2. The flap 5 is arranged in the rear region of the cover 3. The flap 5 is pivotable about a pivot axis 6 relative to the dish 2. This is achieved according to the first embodiment whereby the flap 5 is connected rotatably to the cover 3 via two hinges 7 which serve as articulations. In one alternative embodiment the flap 5 is not rotatably connected to the cover 3 but to the dish 2 via articulations.

The flap 5 is pivotable between a closed state and an open state. FIG. 1 shows the closed state. In the closed state the cover 3 and the flap 5 substantially cover the entire opening of the dish 2.

FIGS. 2 to 4 show a schematic sectional view of the residual water container 1 according to the first embodiment wherein FIG. 2 also shows the closed state and FIGS. 3 and 4 show an open state.

As can be seen by reference to FIG. 2, the flap 5 has a projection 8 with a first flow surface 81 on the side facing the interior of the dish 2. For emptying the residual water container 1 is tilted about a tilt axis which is at least partially parallel to the pivot axis so that the front region of the residual water container 1 is raised and the rear region of the residual water container 1 is lowered.

FIG. 3 shows a situation in which the residual water container 1 is tilted backwards compared to the situation shown in FIG. 2. FIG. 4 shows a situation in which the residual water container 1 is tilted even further backwards than in the situation shown in FIG. 3. FIG. 3 and FIG. 4 show situations in which residual water (not shown in the figures) is poured out of the residual water container 1.

During tilting of the residual water container 1, residual water located in the dish 2 follows gravity and flows in the direction of the rear region of the dish 2. In so doing residual water flows onto the first flow surface 81. As a result of the flow onto the first flow surface, a force F₂ acting on the first flow surface 81 is built up. The build-up of the force F₂ is dynamic in the sense that the force F₂ is built up when residual water flows onto the first flow surface 81. The force F₂ produces a torque M₂. This torque compensates for the torque M₁=d₁×F₁ produced by the weight force F₁ of the flap 5 at least temporarily and at least partially and thus supports or brings about a pivoting of the flap 5; here d₁ is the distance of the centre of gravity P of the flap 5 from the pivot axis 6. This effect is appreciably enhanced according to the first embodiment whereby the side wall 22 runs obliquely to the base 21 at least in a partial region 221 in the rear region of the residual water container 1 and the first flow surface 81 is arranged opposite the oblique region (i.e. in the partial region 221) of the side wall 22. The residual water is supplied to the first flow surface 81 through the oblique region during tilting of the residual water container 1. For the residual water container 1 according to the invention however, it is not absolutely necessary to implement the side wall 22 obliquely in a partial region.

It is preferred that the torque M₁ produced by the weight force F₁ of the flap 5 is completely compensated by the torque M₂ produced by the force F₂ and that a pivoting of the flap 5 relative to the dish 2 about the pivot axis 6 is thus brought about merely by the torque M₂ produced by the force F₂ and thus a pouring opening 9 is exposed through which residual water can flow over the upper edge 23 of the dish 2 from the residual water container 1. It can also be provided within the framework of the invention that the torque M₁ produced by the weight force F₁ of the flap 5 is only partially compensated by the torque M₂ produced by the force F₂.

In the situation shown in FIG. 3 the flap 5 is pivoted compared with the situation shown in FIG. 2 and is located in an open state in which the pouring opening 9 is exposed. In the situation shown in FIG. 4 the flap 5 is pivoted further and therefore the pouring opening 9 is greater than in the situation shown in FIG. 3.

If a sufficient quantity of residual water is located in the dish 2 so that the projection 8 dips into the residual water during tilting of the residual water container 1, a buoyancy force acts on the projection as a result of Archimedes principle. The buoyancy force produces an additional torque which at least partially compensates for the torque produced by the weight force F₁ of the flap 5 and thus supports or brings about the pivoting of the flap 5. The strength of the buoyancy force depends in particular on the size of the projection 8 (which crucially determines the quantity of residual water displaced in each case by the projection 8).

If an even larger quantity of residual water is located in the dish 2, it is possible that the projection 8 already dips into the residual water before tilting of the residual water container 1 and a corresponding buoyancy force is produced. In this case, through a suitable selection of the size of the projection 8 and the arrangements of the projection 8 in relation to the dish 2, it should be avoided that the flap 5 is pivoted merely as a result of a torque produced by the buoyancy force and the flap 5 opens automatically without the residual water container 1 being tilted. This should be ensured at least as long as a predefined maximum filling level of the dish is not exceeded.

It is generally preferred if no closure means are necessary in order to prevent the flap 5 opening without tilting the residual water container 1. As a result, not only the design of the residual water container 1 but also the handling of the residual water container 1 during emptying are simplified since the operator need not act on any closure means to enable an opening of the flap 5.

FIGS. 5 to 7 show the residual water container 1 according to a second embodiment of the invention.

The second embodiment differs from the first embodiment described above in that according to the second embodiment the flap 5 has no projection 8 with a first flow surface 81. Instead, the residual water container 1 according to the second embodiment has a counterweight 10. The counterweight is connected to the flap 5. The weight force of the counterweight F₃ produces a torque M₃=d₃×F₃; d₃ is in this case the distance of the centre of gravity Q of the counterweight from the pivot axis 6. This torque M₃ compensates at least partially for the torque d₁×F₁ produced by the weight force F₁ of the flap 5.

In a preferred specific embodiment the torque d₃×F₃ compensates for the torque d₁×F₁ so that the magnitude of d₃×F₃ and the magnitude of d₁×F₁ are substantially the same. The counterweight 10 then holds the flap 5 in a substantially uniform position with respect to the horizontal. When the residual water container 1 is tilted backwards, the flap 5 remains in its original position. As a result during tilting of the residual water container 1 a pivoting of the flap 5 relative to the dish 2 is thereby brought about.

In an alternative specific embodiment the torque d₁×F₁ is only partially compensated by the torque d₃×F₃. In this case, no pivoting of the flap 5 relative to the dish 2 is brought about by the torque d₃×F₃ alone when the residual water container 1 is titled backwards. Then however only another small torque ΔM=|F₃×d₃|−|F₁×d₁| must be applied to pivot the flap 5. The pivoting of the flap 5 is then accordingly facilitated. ΔM can, for example, be produced by the force with which the residual water presses against the flap 5 during tilting of the residual water container 1 backwards.

Optionally the counterweight 10 has a second flow surface 11. If flow takes place onto the second flow surface 11 during tilting of the residual water container 1, a force is transmitted to the second flow surface 11 which produced a further torque M₄. The torque M₄ helps to compensate for the torque d₁×F₁ produced by the weight force F₁ of the flap 5. The connection 12 of the counterweight 10 to the flap 5 is in this case arranged in a suitable manner relative to the pivot axis 6 that M₄ contributes to the compensation for the torque M₁ produced by the weight force F₁. In the situation shown in FIG. 5 this is achieved for example by the connection 12 being located on the side of the pivot axis 6 facing away from the counterweight 10, i.e. in the figure on the left of the pivot axis 6. The connection 12 can for example comprise a plug-in and/or adhesive connection.

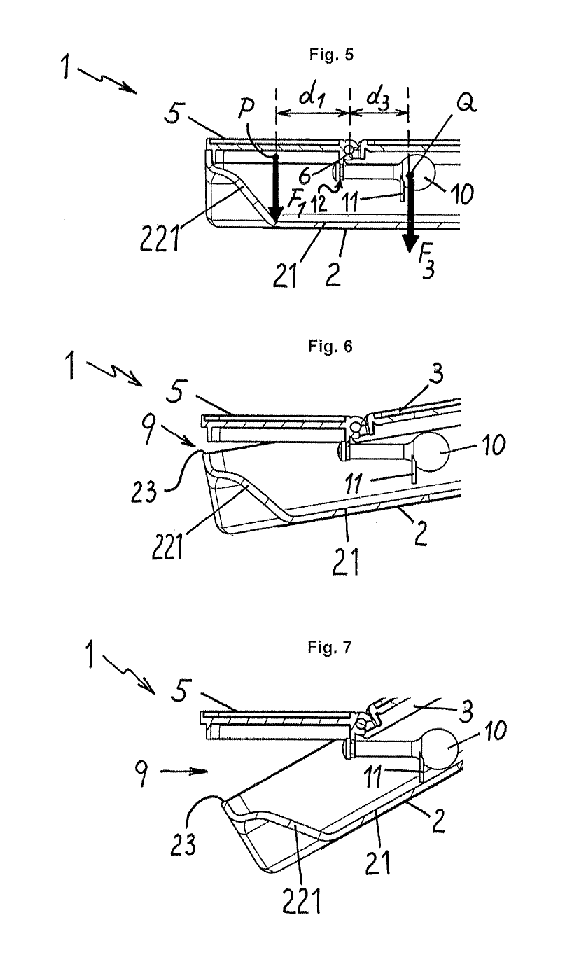

In the situation shown in FIG. 6 the flap 5 is pivoted compared with the situation shown in FIG. 5 and is located in an open state in which a pouring opening 9 is exposed through which residual water can flow over the upper edge 23 of the dish 2 from the residual water container 1. In the situation shown in FIG. 7 the flap 5 is opened further and therefore the pouring opening 9 is larger than in the situation shown in FIG. 6. FIG. 6 and FIG. 7 show situations in which residual water (not shown in the figures) is poured out of the residual water container 1. As soon as the counterweight 10 or the second flow surface 11 impinges upon the base 21 of the dish 2, the flap 5 is no longer pivoted further backwards through further tilting of the residual water container 1; the pouring opening 9 then has its maximum size.

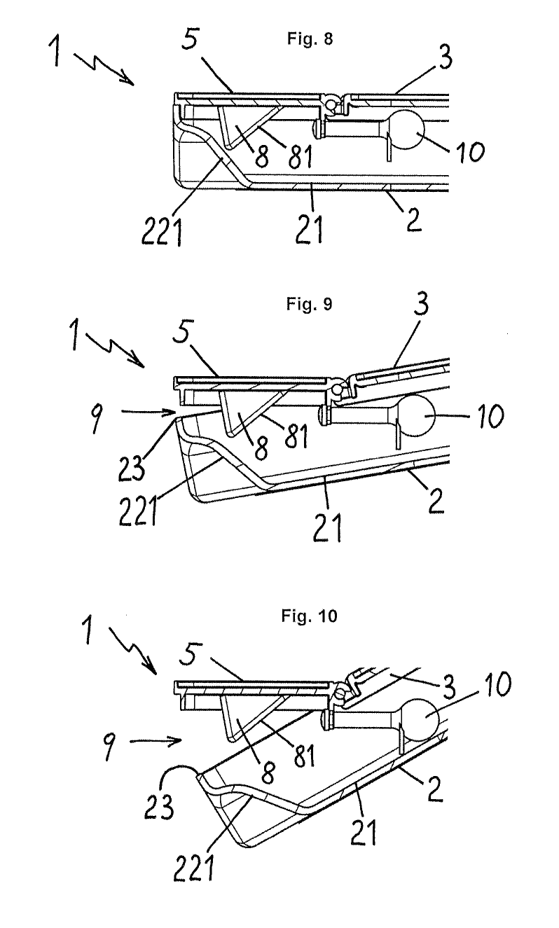

FIGS. 8 to 10 show the residual water container 1 according to a third embodiment according to which the first and the second embodiment are combined with one another.

The residual water container 1 according to the third embodiment has both a flap 5 with a projection 8 and a first flow surface 81 and also a counterweight 10. For the description of the operating mode of the projection 8 and the first flow surface 81 or the counterweight 10 and the optional second flow surface 11, reference is made to the above explanations for the first and second embodiment.

The residual water container 1 according to the invention can be used in an apparatus for beverage preparation. To this end the residual water container 1 is preferably inserted in a compartment provided in the lower region of the apparatus for beverage preparation. Residual water which accumulates during beverage preparation or cleaning of the apparatus for beverage preparation passes at least partially into the residual water container 1. From time to time the residual water container 1 must be emptied. For this purpose the residual water container 1 is separated from the apparatus. This is preferably accomplished by withdrawing it from the apparatus for beverage preparation and thereby holding it in a substantially horizontal position. For emptying the residual water container 1 is tilted backwards by raising the front region of the residual water container 1 and lowering the rear region of the residual water container 1. For this purpose the operator can hold the residual water container 1 with one hand. As described above, during tilting of the residual water container 1 the flap 5 is automatically tilted about the pivot axis 6 relative to the dish 2 and a pouring opening 9 is automatically exposed. The residual water can now be poured out in a controlled manner. When the residual water container 1 is tilted back into a substantially horizontal position after pouring out the residual water, the flap 5 is automatically pivoted back again due to its weight force F₁ and the pouring opening 9 is closed again. The residual water container 1 can now be re-inserted into the apparatus for beverage preparation.

Optionally the residual water container 1 preferably has a handle structure in its front region in order to facilitate for the operator insertion into the apparatus for beverage preparation, withdrawal from the same and emptying of the residual water container 1.

The individual components of the residual water container 1 consist of suitable materials. The dish 2, the cover 3 and the flap 5 preferably consist of a plastic material and/or of a metal, preferably a metal sheet.

Although only a few embodiments of the present invention have been shown and described, it is to be understood that many changes and modifications may be made thereunto without departing from the spirit and scope of the invention.

What is claimed is:

1. A residual water container for an apparatus for beverage preparation comprising:
a dish having at least one interior for receiving residual water and having an opening which is delimited by an upper edge of the dish,
a cover for covering a first partial region of the opening of the dish and
a flap for temporary covering of a second partial region of the opening of the dish,
wherein the flap is pivotable relative to the dish about a pivot axis so that the flap is pivotable between a closed state and an open state,
wherein in the open state a pouring opening of the residual water container is exposed through which pouring opening residual water can be poured out over the upper edge of the dish and
wherein in the closed state the pouring opening is closed.

2. The residual water container according to claim 1, wherein the flap has at least one projection on a side facing the at least one interior of the dish, wherein the at least one projection has at least one first flow surface, wherein the at least one first flow surface is configured to have residual water flowing out of the dish when tilting the residual water container flowing onto it and thereby producing a torque acting on the flap.

3. The residual water container according to claim 1, wherein the flap has at least one projection on the side facing the at least one interior of the dish and wherein the projection is configured as a buoyancy body.

4. The residual water container according to claim 1, further comprising at least one counterweight, wherein the at least one counterweight is connected to the flap and wherein the at least one counterweight is arranged in relation to the flap and the pivot axis of the flap in such a manner that the in relation to the pivot axis of the flap, which at least partially compensates for a corresponding torque (F₁×d₁) produced by a weight force (F1) of the flap.

5. The residual water container according to claim 4, wherein the at least one counterweight has at least one second flow surface, wherein the at least one second flow surface is configured to have residual water flowing out of the dish when tilting the residual water container flowing onto it and thereby producing a torque acting on the flap.

6. The residual water container according to claim 1, wherein the cover has a platform for placing drinks containers thereon.

7. The residual water container according to claim 6, wherein the platform is arranged on a side of the cover opposite the flap.

8. The residual water container according to claim 1, wherein the dish has a base and a side wall, wherein the side wall is configured to run obliquely to the base at least in a partial region.

9. The residual water container according to claim 2, wherein the dish has a base and a side wall, wherein the side wall is configured to run obliquely to the base at least in a partial region and wherein the at least one projection is opposite the partial region of the side wall, in which the side wall is configured to run obliquely to the base.

10. The residual water container according to claim 1, wherein the cover is detachably connected to the dish.

11. The residual water container according to claim 10, wherein the cover is non-positively and/or positively connected to the dish.

12. The residual water container according to claim 1, wherein the flap is attached pivotably to the cover via at least one hinge.

13. An apparatus for beverage preparation comprising a beverage preparation unit and a residual water container according to claim 1.

14. The apparatus according to claim 13, wherein the residual water container can be removed from the apparatus.

15. The apparatus according to claim 13,
wherein in one operating state of the apparatus the residual water container is arranged in a lower region of the apparatus and/or wherein the apparatus has at least one beverage outlet opening below which the cover has a platform for placing drinks containers thereon.

16. The apparatus according to claim 13, wherein the apparatus is a coffee machine, a coffee machine for preparing espresso and/or cappuccino, a fully automatic coffee machine or a fully automatic coffee machine for preparing espresso and/or cappuccino.
